(19) United States
(12) Patent Application Publication
(10) Pub. No.: US 2009/0260897 A1
(43) Pub. Date: Oct. 22, 2009

(54) CAPACITIVE TOUCH SENSOR

(75) Inventor: Ross Kruse, Salem, OR (US)

Correspondence Address: ALLEMAN HALL MCCOY RUSSELL & TUTTLE LLP, 806 SW BROADWAY, SUITE 600, PORTLAND, OR, 97205-3335, US

(73) Assignee: INFOCUS CORPORATION, Wilsonville, OR (US)

(21) Appl. No.: 12/425,131

(22) Filed: Apr. 16, 2009

Related U.S. Application Data
(60) Provisional application No. 61/045,555, filed on Apr. 16, 2008.

(51) Int. Cl. G08C 21/00

(52) U.S. Cl. 178/18.01

(57) ABSTRACT

A capacitive touch sensor is provided. The capacitive touch sensor may include a printed circuit board coupled to one or more electronic components, a sensing pad coupled to the circuit board, the sensing pad configured to detect touch input, a touch surface positioned in a cooperative position with the circuit board and the sensing pad, and a dielectric material interposed by the sensing pad and the touch surface, the dielectric material having a dielectric constant greater than air at a substantially equivalent temperature and pressure.

### CROSS-REFERENCE TO RELATED APPLICATIONS

This application claims priority from U.S. Provisional Patent Application Ser. No. 61/045,555 of Ross Kruse, entitled “CAPACITIVE TOUCH SENSOR,” filed Apr. 16, 2008, the disclosure of which is hereby incorporated by reference in its entirety and for all purposes.

### BACKGROUND

A variety of electronic devices may use capacitive touch sensors to gather touch input data. Example, electronic devices utilizing a capacitive touch sensor may include: laptop computers, automated teller machines AMT's, personal data organizers, personal media players, display devices, such as projectors, and various others. Capacitive touch sensors may provide increased interactivity and adaptive capabilities when compared to input devices such as keyboard, keypads, scroll wheels, mice, mechanical switches, etc., enhancing user interaction with the computing device. Consequently, when capacitive touch sensors are utilized, a user may be able to more effectively and efficiently control the electronic device.

Capacitive touch sensors may include a touch surface, a sensing pad, and a printed circuit board coupled to the sensing pad. Due to certain electronic characteristics and packaging limitations, capacitive touch sensors may include an air gap located between a touch surface and a sensing pad. Reducing and possibly minimizing the air gap between the sensing pad and the touch surface may increase the performance of the capacitive touch sensor, enhancing operation and reducing sensing variability. However, various components, coupled to the printed circuit board (PCB), may increase the size of the air gap. In turn, the increased air gap may impede, and in some cases inhibit, interaction between the sensing pad and a digit or stylus used to perform a touch input on the touch surface. Therefore, the air gap may decrease the capacitive touch sensor's ability to reliably gather touch input data.

### SUMMARY

As such in one embodiment, a capacitive touch sensor is provided. The capacitive touch sensor may include a printed circuit board coupled to one or more electronic components, a sensing pad coupled to the circuit board, the sensing pad configured to detect touch input, a touch surface positioned in a cooperative position with the circuit board and the sensing pad, and a dielectric material interposed by the sensing pad and the touch surface, the dielectric material having a dielectric constant greater than air at a substantially equivalent temperature and pressure.

In this way, the variabilities in the capacitance may be reduced, increasing the reliability and predictability of the touch screen.

### BRIEF DESCRIPTION OF THE FIGURES

FIG. 1 shows a schematic depiction of an embodiment of an electronic device with a capacitive touch sensor.

FIG. 2 shows side view of a prior art capacitive touch sensor.

FIG. 3 shows a side view of an embodiment of a capacitive touch sensor.

FIG. 4 illustrates a top view of the touch surface included in the capacitive touch sensor shown in FIG. 3.

FIG. 5 shows a top view of the sensing pad included in the capacitive touch sensor illustrated in FIG. 3.

### DETAILED DESCRIPTION

The present disclosure is directed to an electronic device with touch sensitive features. As an example, the electronic device may include a capacitive touch sensor. Under some conditions the capacitive touch sensor may detect interactions between a digit of a user or a stylus and the capacitive touch sensor.

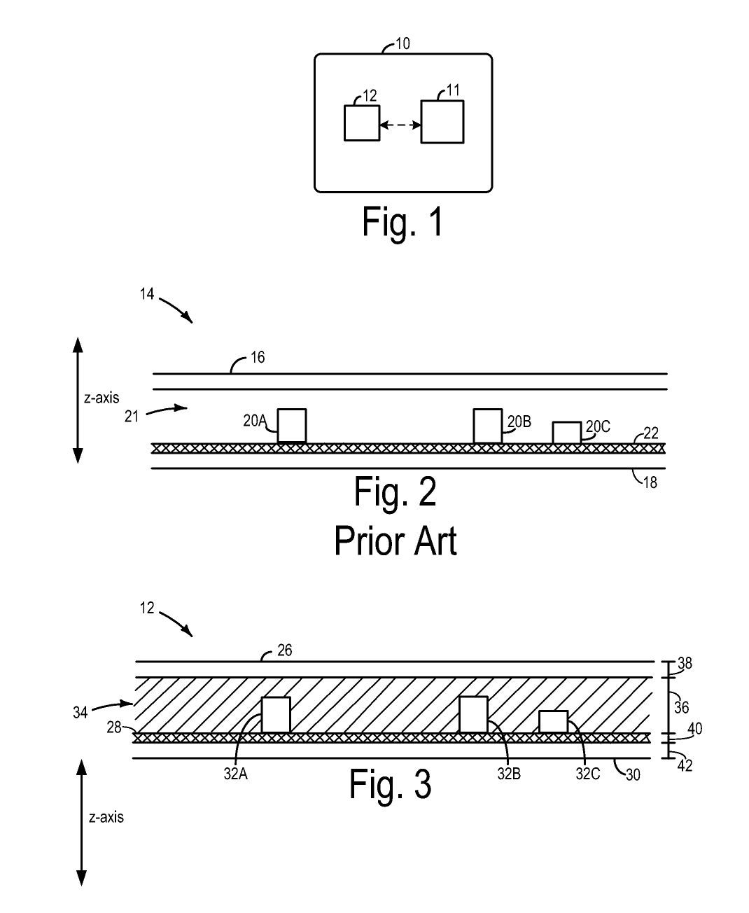

A schematic depiction of an electronic device 10 having touch sensitive capabilities, is shown in FIG. 1. The electronic device may include but is not limited to: a display device, such as a projection device, a computing device, a computer display, a portable media player, etc. As an example, the electronic device, such as a display device, may include, but is not limited to televisions, monitors, and projectors that may be adapted to display images, including text, graphics, video images, still images, presentations, etc. Such image devices may be found in home environments and applications, education environment and applications, business facilities, conference rooms and other meeting facilities, etc. The following is a non-exhaustive list of exemplary image devices: cathode ray tubes (CRTs), projectors, flat panel liquid crystal displays (LCDs) systems, LED systems, plasma systems, front projection systems, rear projection systems, LCD monitors, etc.

A content source may be communicatively linked to the display device to enable transmission of content for display on the display device. Any suitable communication method may be used to transmit the image, including but not limited to wireless transmission, wired transmission, etc. Further, the content sources may be computers, laptop computers, personal computers, storage mediums, such as memory cards and other memory devices, cameras, telephones, smart-phones, portable data assistants, etc.

Typically, the display device includes a body or housing. Contained within the housing may be light source and an image-generation device. The light source may be adapted to produce a beam of light and project the light towards the image-generation device, which may be configured to generate and project an image.

In some embodiments, the light source may include a lamp positioned within a reflector that is configured to direct most of the emitted light along an optical path of the system. The light source may include any suitable type of lamp. Examples include, but are not limited to, metal halide lamps and ultra-high-pressure (UHP) arc lamps, lasers, light emitting diodes (LED), organic light emitting diodes, etc. The system also may include one or more filters, such as an infrared (IR) or ultraviolet (UV) filter, to filter out unwanted parts of the emission spectra of the lamp.

The image-generation device may be configured to receive the light from light source and generate an image to be projected. The image-generation device may include an optical engine, image-producing element, filters, color wheels, lenses, mirrors, integrators, condensers, and other suitable optical elements. Such elements may be configured to generate an image. For example, the image generation device may include an image-producing element, such as, but not limited to, a digital micromirror (DMD), an LCD panel, or any other suitable image source. In some embodiments, the image-producing element may be configured to project light toward one or more lenses, mirrors or other optics, which, in turn, may be configured to project light toward the display surface.

A control system 11 may be provided with the display device to enable a user to select and/or alter features or functions on the device. Various user inputs, coupled to the control system, may be retained on the body of the display device to enable the user to select and alter functions or features, including focus features, keystone features, color features, contrast and brightness features, input content calibration features, display size features, etc.

In the depicted embodiment, the control system may be coupled to a capacitive touch sensor 12. Thus control system 11 may receive inputs from the capacitive touch sensor. However, it will be appreciated that in other embodiments, capacitive touch sensor 12 may be included in control system 11. The capacitive touch sensor may be configured to detect touch inputs. A user may actionably interact with the touch surface via an appendage, such as a digit, or a stylus, such as a pen. After the actionable interaction, the electronic device may determine the specific type of touch input, and from this determination trigger various actions in the electronic device. For example, a touch input may trigger adjustment of image characteristics (e.g. opacity, brightness, saturation, etc.) within a display device. Capacitive touch sensor 12 is described in more detail herein with regard to FIG. 3. It will be appreciated that the capacitive touch sensor may be implemented as a group of control buttons. The control buttons may be on a surface of the projector to enable a user to control display of the image.

Now turning to FIG. 2, a schematic depiction of a capacitive touch sensor utilized in a prior art device is illustrated. Capacitive touch sensor 14 may include a touch surface 16, a printed circuit board (PCB) 18, and electronic components 20A, 20B, and 20C. Furthermore, a sensing pad 22 may be coupled to the PCB. The sensing pads may interact with a digit placed on or proximate to the touch surface, allowing the device to detect a change in capacitance of the sensing pad. A region 21, located between the touch surface and the PCB, is typically filled with air. It may be desirable to decrease the thickness of region 21 to reduce the air gap between the touch surface and the sensing pad. The thickness of region 21 refers to a distance along the z-axis, as depicted in FIG. 2. However, the thickness of the electronic components, 20A, 20B, and 20C, may prevent such a reduction in thickness. Consequently, a digit or stylus may not be able to properly interact with the sensing pad. Improper interaction may decrease the reliability of the device and in some cases render the device inoperable, increasing user frustration when operating the electronic device. It may be impractical, expensive, and under some circumstance impossible to adjust the size of the electronic components, while retaining the functionality of the capacitive touch sensor.

FIG. 3 shows a schematic representation of a capacitive touch sensor 12 according to the present disclosure. The capacitive touch sensor may include a touch surface 26 in a cooperative position with a sensing pad 28, the sensing pad may also be included in the capacitive touch sensor. A cooperative position may include a position in which manipulators placed on the touch surface can interact with the sensing pad. In one example, the touch surface may be position above the sensing pad. However, it will be appreciated that other arrangements are possible, in other examples. In some embodiments, sensing pad 28 may include a layer of indium tin oxide configured to conduct a continuous electric current across the sensing pad during operation of the capacitive touch sensor. Sensing pad 28, under some conditions, may determine a change in capacitance caused by a touch input. In this way movements of a user, on or near the touch surface via a digit or stylus, may be detected. Thus, touch input data may be generated when a touch input is performed on or proximate to a touch surface 26.

The capacitive touch sensor may further include a PCB 30 coupled to sensing pad 28. The PCB allows the capacitive touch sensor to mechanically support as well as electronically couple electronic components, 32A, 32B, and 32C, using conduit pathways. Therefore, the electronic components may protrude from the PCB. As depicted, the electronic components have varying thicknesses. The thickness of the electronic components may refer to the length of the electronic components along the z-axis. It will be appreciated that the z-axis may be perpendicular to the touch surface in some examples. Furthermore, it will be appreciated that the z-axis is a relative coordinate axis. That is to say that the z-axis may not be orientated in a vertical direction relative to the surface of the earth. For example, the capacitive touch sensor may be mounted on the side of a projection device, therefore the z-axis may be parallel to a horizontal direction. It will be appreciated that numerous orientations are possible, in other examples. Furthermore, the thicknesses of the electronic components may be similar (e.g. substantially identical), in other embodiments. The electronic components coupled to the circuit board may include: microchips, resistors, capacitors, etc. Although PCB 30 and the sensing pad 28 are depicted as separate layers, it will be appreciated that in some embodiments the sensing pad may be integrated into the PCB or alternatively the sensing pad may be positioned beneath the PCB.

A dielectric material 34, which may be compressible, may be included in the capacitive touch sensor. The dielectric material may be interposed by sensing pad 28 and touch surface 26. Thus, in some examples, the dielectric material may substantially span a length between the sensing pad and the touch surface. Additionally, in some examples, the dielectric material may be configured to substantially surround and/or extends beyond the electronic components (32A, 32B, 32C) in a direction along the z-axis. The dielectric material may be a suitable material, such as a polymeric foam, an elastomeric material, etc.

Further, in some examples, the dielectric material may provide structural support for one or more of the sensing pad and/or the touch surface. For example, the dielectric foam may be a solid, providing an understructure for the sensing surface and/or the sensing pad.

The compressible dielectric material may have a dielectric constant greater than air at a substantially equivalent temperature and pressure {e.g. standard temperature and pressure (STP)}, allowing predictable and reliable interaction between the touch surface and the sensing pad. In some examples, the standard temperature is 20° C. and the standard pressure is 101.325 kPa. In this way, the compressible dielectric material may reduce the variability of capacitance detected via sensing pad 28, when compared to the prior art device shown in FIG. 2. Thus, the performance and reliability of capacitive touch sensor 12 may be increased when a dielectric material is utilized.

Dielectric material 34 may have a thickness 36, touch surface 26 may have a thickness 38, the sensing pad 28 may have a thickness 40, and the PCB 30 may have a thickness 42. The thickness of the aforementioned components may be defined as the components length along the z-axis. The thickness of the dielectric material 34 may be selected based on one or more of the following parameters: the thickness of the touch surface, the thickness of the PCB, and the dielectric constant of the dielectric material and/or the touch surface.

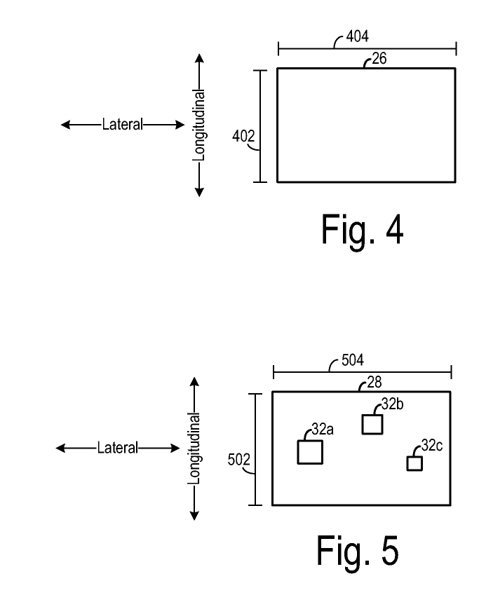

Turning now to FIG. 4 which depicts a top view of touch surface 26. In this example, the touch surface is substantially flat and has a longitudinal and a lateral length, 402 and 404, respectively. However, it will be appreciated that, in other examples the geometry of the touch surface may be altered. For example, the touch surface may be curved, sloped, etc. It will be appreciated that dielectric material 34 may substantially span the longitudinal and/or lateral length of touch surface 26. Additionally, a casing (not shown) may surround the periphery of the touch surface, preventing the touch surface from being damaged. The casing may enclose at least a portion of PCB 30, illustrated in FIG. 3.

FIG. 5 illustrates a top view of sensing pad 28 and PCB 30. In this example, the sensing pad has a longitudinal and a lateral length, 502 and 504 respectively. The sensing pad may have varying geometries and/or size. It will be appreciated that dielectric material 34 may substantially span the longitudinal and/or lateral length of sensing pad 28.

In some embodiments, capacitive touch sensor 12 decreases the variability in the capacitance of the touch sensor, thereby increasing the device's reliability. In this way the capacitive touch sensor may be inexpensively improved.

Although the present disclosure includes specific embodiments, specific embodiments are not to be considered in a limiting sense, because numerous variations are possible. The subject matter of the present disclosure includes all novel and nonobvious combinations and subcombinations of the various elements, features, functions, and/or properties disclosed herein. The following claims particularly point out certain combinations and subcombinations regarded as novel and nonobvious. These claims may refer to “an” element or “a first” element or the equivalent thereof. Such claims should be understood to include incorporation of one or more such elements, neither requiring, nor excluding two or more such elements. Other combinations and subcombinations of features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A capacitive touch sensor comprising:
a printed circuit board coupled to one or more electronic components;
a sensing pad coupled to the circuit board, the sensing pad configured to detect touch input;
a touch surface positioned in a cooperative position with the circuit board and the sensing pad; and
a dielectric material interposed by the sensing pad and the touch surface, the dielectric material having a dielectric constant greater than air at a substantially equivalent temperature and pressure.

2. The capacitive touch sensor of claim 1, wherein the dielectric material is compressible.

3. The capacitive touch sensor of claim 2, wherein the dielectric material is a polymeric foam.

4. The capacitive touch sensor of claim 2, wherein the dielectric material is an elastomeric material.

5. The capacitive touch sensor of claim 1, wherein the dielectric material is configured to substantially surround the electronic components included in the circuit board.

6. The capacitive touch sensor of claim 1, wherein the sensing pad includes a layer of indium tin oxide configured to conduct a continuous electric current across the sensing pad during operation of the touch sensor.

7. The capacitive touch sensor of claim 1, wherein the dielectric material substantially spans the longitudinal and lateral lengths of one or more of the sensing pad and the touch surface.

8. The capacitive touch sensor of claim 1, wherein the dielectric material substantially spans a length between the circuit board and the touch surface.

9. The capacitive touch sensor of claim 1, wherein a thickness of the dielectric material is selected based on one or more of the following parameters: a thickness of the touch surface, a thickness of the printed circuit board, and a dielectric constant of the dielectric material and/or the touch surface.

10. The capacitive touch sensor of claim 1, wherein the sensing pad is integrated into at least a portion of the printed circuit board.

11. An electronic device having touch sensitive capabilities comprising:
a capacitive touch sensor including a touch surface positioned in a cooperative position with a printed circuit board, one or more electronic components protruding from and coupled to the printed circuit board, a sensing pad coupled to the printed circuit board, the sensing pad configured to conduct an electric current during operation of the electronic device, and a dielectric material interposed by the sensing pad and the touch surface; and
a control system configured to receive inputs from the capacitive touch sensor.

12. The electronic device of claim 11, wherein the dielectric constant of the dielectric material at a standard temperature and pressure is greater than the dielectric constant of air at the standard temperature and pressure.

13. The electronic device of claim 11, wherein the dielectric material is compressible.

14. The electronic device of claim 13, wherein the dielectric material is configured to conform to the shape of the electronic components.

15. The electronic device of claim 11, wherein the dielectric material substantially spans a length between the substrate of the printed circuit board and the touch surface.

16. An electronic device having touch sensitive capabilities comprising:
a capacitive touch sensor including a touch surface positioned in as cooperative position with a printed circuit board, one or more electronic components protruding from and coupled to the printed circuit board, a sensing pad coupled to the printed circuit board, the sensing pad including a layer of indium tin oxide, and a compressible dielectric foam interposed by the printed circuit board and the touch surface and substantially spanning a length between the touch surface and the sensing pad, the dielectric foam having a dielectric constant greater than air at a substantially equivalent temperature and pressure; and
a control system configured to receive inputs from the capacitive touch sensor.

17. The electronic device of claim 16, wherein the sensing pad is integrated into the printed circuit board.

18. The electronic device of claim 16, wherein the electronic components have varying thicknesses.

19. The electronic device of claim 18, wherein the dielectric material extends beyond the electronic components in a direction towards the touch surface.
